(19) United States
(12) Patent Application Publication
(10) Pub. No.: US 2009/0226138 A1
(43) Pub. Date: Sep. 10, 2009

(54) Fibre-Optic Module

(75) Inventors: Anthony Edward Kelly, Ayrshire (GB); Craig Tombling, Oxford (GB); Robert William Press, West Lothian (GB)

Correspondence Address: HARNESS, DICKEY & PIERCE, P.L.C., P.O. BOX 828, BLOOMFIELD HILLS, MI, 48303, US

(73) Assignee: Amphotonix Limited, Glasgow (GB)

(21) Appl. No.: 12/085,596

(22) PCT Filed: Nov. 28, 2006
(86) PCT No.: PCT/GB2006/004431

§ 371 Date: Apr. 14, 2009

(30) Foreign Application Priority Data
Nov. 28, 2005 (GB) 0524217.7

(51) Int. Cl. G02B 6/36

(52) U.S. Cl. 385/89

(57) ABSTRACT

A fibre-optic module incorporating a semiconductor optical amplifier is compatible with a standard specification for a fibre-optic transceiver module, which is typically pluggable. The module comprises optical connectors capable of connection to first and second optical fibres and being in accordance with said standard specification and the input optical signal received from the first optical fibre is amplified by the semiconductor optical amplifier and supplied to the second optical connector for transmission along the second optical fibre. The module further comprises an electrical parallel connector having a physical configuration in accordance with said standard specification and a control circuit which receives control signals from the electrical parallel connector and to control the operation of the optical amplifier. Thus the module maybe connected to a standard electrical backplane alongside fibre-optic transceiver modules to augment the optical performance of the transceiver modules.

The present invention relates to the field of fibre-optic communications and in particular to the use of transceiver modules which may be connected to an electrical backplane and which are capable of converting an input optical signal from one optical fibre into an electrical signal and are also capable of an electrical signal into an output optical signal.

In the field of fibre-optic data communication, there has been a strong move toward transceiver modules, especially pluggable transceiver modules. Such transceiver modules contain the optics and the electronics in a very small footprint module that may be connected to an electrical backplane arranged to receive multiple such transceiver modules. Plural electrical backplanes are typically arranged in a rack to provide signal routing functions. In the case of pluggable transceiver modules, the module is simply plugged into the backplane, thereby allowing plug and play functionality. Although these modules were first used in datacomms applications to connect routers and other equipment, there has been a migration towards their use in a more traditional telecoms environment where line cards with discrete components have been traditionally used. The electrical-to-optical conversion is performed by a transmitter such as a laser diode. The optical-to-electrical conversion is performed by a receiver such as a PIN diode detector which is a separate component from the transmitter.

Early uncooled transceiver modules were only suitable for 1300 nm or CWDM applications due to their lack of wavelength stability, More recently, cooled transmitter subassemblies for use in transceiver modules have been implemented, allowing their use in DWDM applications. Typically, the transceiver module has a control circuit in the form of a PIC (Peripheral Interface Controller) microcontroller which allows it to be controlled in an intelligent and flexible manner.

An example of a transceiver module is disclosed in the related applications U.S. Pat. No. 5,879,173 and U.S. Pat. No. 6,267,606. More recently, a number of different standard specifications for the transceiver module have been developed and commercially available transceiver modules are arranged in accordance with one or more of the standard specifications. As for other technical products, such standard specifications allow for interchangeability of the transceiver modules and backplanes and for sourcing from multiple suppliers. Examples of the standard specifications are the SFP specification, the XFP specification, the XPAK specification, the SFF specification, the XENPAK specification, and the X2 specification. Each of these standard specification is for a pluggable transceiver module except the SFF transceiver module in which the electronic parallel connector is connected to the backplane by soldering or the like.

Although existing transceiver modules provide a wide range of functionality and are a powerful tool, it is always desirable to improve their performance. To this end there has been ongoing development of the designs of all the sub-assemblies of the transceiver modules, to improve both optical performance and the performance of the electronics.

According to a first aspect of the present invention, there is provided a fibre-optic module comprising:

an electrical parallel connector having a configuration allowing the electrical parallel connector to be connected to an electrical backplane for receiving fibre-optic transceiver modules;

first and second optical connectors capable of connection to first and second optical fibres to receive an input optical signal from the first optical fibre and to transmit an output optical signal along the second optical fibre;

an optical amplifier;

an optical circuit arranged to pass the input optical signal received from the first optical fibre to the optical amplifier for amplification, and to pass the amplified optical signal output from the optical amplifier to the second optical connector for transmission as the output optical signal along the second optical fibre;

a control circuit arranged to receive control signals from the electrical parallel connector and to control the operation of the optical amplifier in response to said control signals.

Typically, the module has an external configuration in accordance with a standard specification for a fibre-optic transceiver module, and thus the optical connectors are in accordance with said standard specification and the electrical parallel connector has a physical configuration in accordance with said standard specification. In many cases, but not essentially, the electrical parallel connector has a configuration allowing it to be plugged into an external electrical connector of the electrical backplane.

According to a second aspect of the present invention, there is provided a fibre-optic module comprising:

an electrical parallel connector having a configuration allowing the electrical parallel connector to be connected to an electrical backplane for receiving fibre-optic transceiver modules;

an optical connector capable of connection to an optical fibre to receive an input optical signal from the optical fibre and to transmit an output optical signal along the optical fibre;

an optical amplifier;

a reflector;

an optical circuit arranged to pass the input optical signal received from the optical fibre to the optical amplifier, the reflector being arranged to reflect the light after a first pass through the optical amplifier back through the optical amplifier, and the optical circuit being arranged to direct the light output from the optical amplifier after a second pass through the optical amplifier back to the optical connector for transmission as the output optical signal along the optical fibre;

a control circuit connected to the electrical parallel connector and arranged to control the operation of the optical amplifier.

Thus in accordance with the invention, an optical amplifier is packaged in a fibre-optic module, often a pluggable fibre-optic module, which is compatible with the type of fibre-optic transceiver module described above. The users (including carriers/enterprises and equipment manufacturers) of the existing transceiver modules use electrical backplanes (or cards) in racks with each backplane having locations for multiple transceiver modules. The fibre-optic module in accordance with the invention may be utilised by such users of transceiver modules to considerable advantage. As the fibre-optic module in accordance with the invention has an external configuration and an electrical parallel connector which matches that of the existing transceiver modules, it may be employed in the same electrical backplane as the transceiver modules. The fibre-optic module in accordance with the invention may be connected to the backplane in the same manner as the existing transceiver module, for example by simple plugging in the case of a standard specification for pluggable modules. Similarly, the optical connectors allow the same type of optical fibres to be connected to the fibre-optic module in accordance with the invention as to the transceiver modules allowing ease of incorporation into the overall optical circuit.

Once incorporated with transceiver modules on a backplane, the fibre-optic module in accordance with the invention may be used to augment the optical performance of the transceiver modules, for example by amplifying optical signals input to and output from transceiver modules. The user of the transceiver modules will have link budget issues, especially as the use of these transceiver modules becomes ever more widely accepted for longer reach systems and the fibre-optic module in accordance with the invention allows these to be managed. For example, the fibre-optic module in accordance with the invention might amplify an optical signal input to a transceiver module in order to meet the dynamic range of the receiver, or might amplify an optical signal output from a transceiver module to compensate for insufficient output power of the transmitter. In the case of the receiver requirement, the amplifier is capable of amplifying multiple optical signals arranged at different wavelengths for later separation and distribution into a series of receivers.

Other possible uses include wavelength conversion, regeneration and pulse shaping with cross gain and cross phase operation. Cross gain modulation typically requires agile narrow band filtering. Cross phase modulation requires a twin SOA interferometer. The wavelength conversion function is attractive for wavelength agility in wavelength division multiplexed systems.

Whereas the standard transceiver modules which have a separate receiver optical subassembly (ROSA) and transmitter optical subassembly (TOSA), the fibre-optic module in accordance with the invention is significantly different. That is, the optical circuit of the fibre-optic module in accordance with the first aspect of the invention is double-ended, that is the light from the input passes to the output. The optical circuit of the fibre-optic module in accordance with the second aspect of the invention is single-ended (or can comprise two separate singled-ended circuits), but the input and output optical signals are transmitted on the same optical fibre.

Notwithstanding these differences, as the electrical parallel connector has the same configuration as that of the transceiver module, the control circuit of the fibre-optic module in accordance with the invention may be arranged to provide a very similar electrical interface to that of the transceiver modules. Thus same level of intelligent control and reporting is straightforwardly implemented. For example, the control circuit may be a PIC microcontroller and using similar control signals to the transceiver module, the operation and gain of the optical amplifier may be controlled. Similarly, appropriate monitor signals may be output to the host system, for example monitor signals which allow to be recognised by the host system as an amplifier, or which provide optical input and optical output power reporting, reporting of errors and/or reporting of other operational parameters of the module.

In general, the invention is applicable to any type of existing or future transceiver module design, including but not limited to transceiver modules in accordance with the SFP specification, the XFP specification, the XPAK specification, the SFF specification, the XENPAK specification, or the X2 specification.

In general, the invention may be implemented with any type of optical amplifier but particular advantage is achieved by use of a semiconductor optical amplifier (SOA). Power performance is critical and a fundamental part of the standards for transceiver modules. The ability to operate an SOA at low drive current, together with the ability to operate an SOA without cooling or with minimal or reduced cooling, provides the capability of implementing an optical amplifier without exceeding the power limitations of the standard in question. As to the cooling requirements, semi-cooled operation is an established requirement for transmitter function in a transceiver module, for example where an SOA is cooled to approximately 40° C. rather than the usual 20° C. In contrast, the need for pump modules with high laser drive current limits the use of other optical amplifiers such as doped fibre amplifiers and doped waveguide amplifiers, in particular EDFAs and EDWAs, in a transceiver module. Here, even though pumps are often uncooled, the power requirement and heat dissipation required is significant which makes it difficult to meet the power limitations of the standard in question.

Use of a semiconductor optical amplifier also allows a small form factor of the overall optical subassembly to be achieved which facilitates meeting the space constraints imposed by the standard specification for the transceiver module. Other optical amplifiers such as doped fibre amplifiers and doped waveguide amplifiers, in particular EDFAs and EDWAs, are possible but for any given standard specification there is more difficulty in accommodating the necessary components, in particular the fibre or waveguide itself and the pump laser.

In the case of a semiconductor optical amplifier, a number of techniques may be applied to assist in minimising the size of the optical subassembly to allow it to fit in the available space, as follows.

Advantageously, the optical circuit comprises a train of optical elements with free space therebetween.

In the present context, this provides advantage over the use of a waveguide arrangement in which light is directed from the connectors to the semiconductor optical amplifier along waveguides. On first impression a waveguide arrangement might be considered to be more compact. However, in practice the optical train arrangement provides a more compact optical subassembly overall when account is also taken of coolers to meet the necessary cooling requirement. Heat is generated not only by the semiconductor optical amplifier but also from the surrounding environment, including heat from coolers themselves. Heat generation and cooling is a particular issue in the present context of fibre-optic module which in use is mounted on a backplane with transceiver modules. In such locations radiation of heat is limited due to the close proximity of other modules and components, thermal radiation being predominantly through the housing of the connectors. In the case of a waveguide arrangement, the components incorporating the waveguides are coupled to the semiconductor optical amplifier and the entire unit must be cooled, requiring a large cooler. In contrast, with an optical train arrangement, the cooling requirement is eased. It is necessary to cool little more than the semiconductor optical amplifier, possibly with adjacent components such as a lens. This is because the optical train arrangement is tolerant to relative movements of the optical elements caused by relative thermal expansion and contraction. The reduced heating requirement allows the use of a smaller cooler which in turn reduces the overall size of the optical subassembly.

Advantageously, the optical circuit comprises at least one lens on the input side of the optical amplifier arranged to direct the light of the input optical signal onto the semiconductor optical amplifier, and at least one lens on the output side of the optical amplifier arranged to collect the light of the output optical signal from the semiconductor optical amplifier.

The use of lenses facilitates the optical train nature of the optical circuit. It negates the need for the use of lensed fibres for coupling to and from the SOA and overcomes the issue of fibre bend radius. The use of lenses enables the use of free-space isolators.

Advantageously in the case of the first aspect of the invention, the first and second optical connectors are alongside each other, and the optical circuit includes a pair of reflectors arranged to direct the light passed through the optical circuit from the first optical connector to the second optical connector. In this case, advantageously the semiconductor optical amplifier is arranged in the optical circuit between the pair of reflectors.

Thus, the semiconductor optical amplifier is able to be placed relatively close to the optical connectors. The optical subassembly generates heat whether the semiconductor optical amplifier is a cooled or uncooled variety and this is radiated from the housing of the optical connectors. In contrast, in the case of an EDFA or a EDWA a pump laser is required and arranging for the heat to be radiated from this housing is more difficult owing to the pump being separate to the optical path of the signal for amplification. Cooling of any active component (pump laser, semiconductor optical amplifier, transmitter laser) is vital and small size allows proximity to the radiating surfaces.

Advantageously in the case of the first aspect of the invention, the optical circuit comprises first and second isolators, the optical circuit being arranged to pass the input optical signal received from the first optical fibre through the first isolator before the semiconductor optical amplifier, and to pass the amplified optical signal output from the semiconductor optical amplifier through the second isolator before the second optical connector.

The use of discrete isolators overcomes the space limitation associated with the use of fibre based isolators. Fibres have a bend radius limited inconsistent with the size of the module. The incorporation of fibre-based isolators allows the use of non-angled fibre connectors. Its is usual to use angled fibre connectors to overcome reflections into the amplifier. These are not required where isolation is used. Using non-angled connectors is then consistent with those used on the neighbouring transceiver modules.

To allow better understanding, an embodiment of the present invention will now be described by way of non-limitative example with reference to the accompanying drawings, in which:

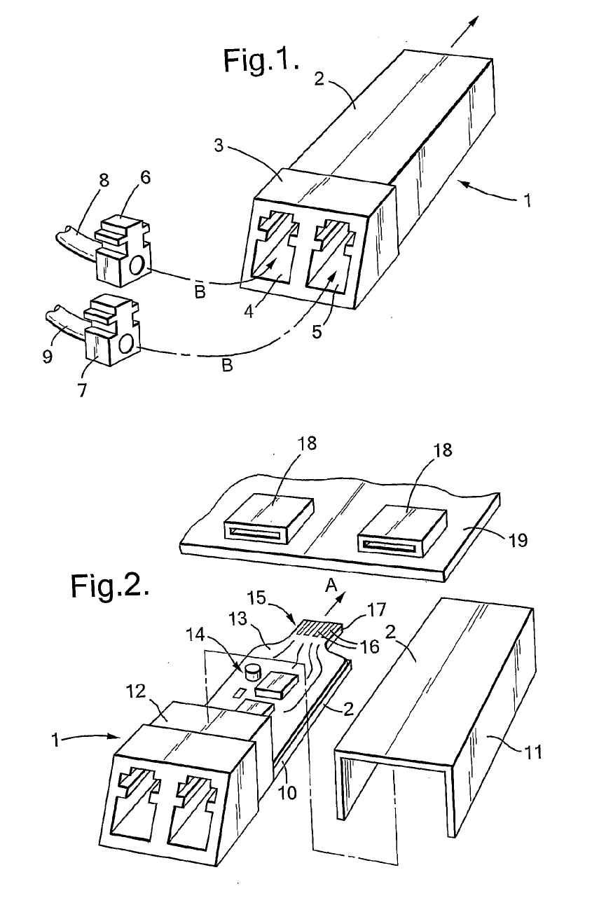

FIG. 1 is a perspective view of a fibre-optic module;

FIG. 2 is an exploded perspective view of the fibre-optic module of FIG. 1;

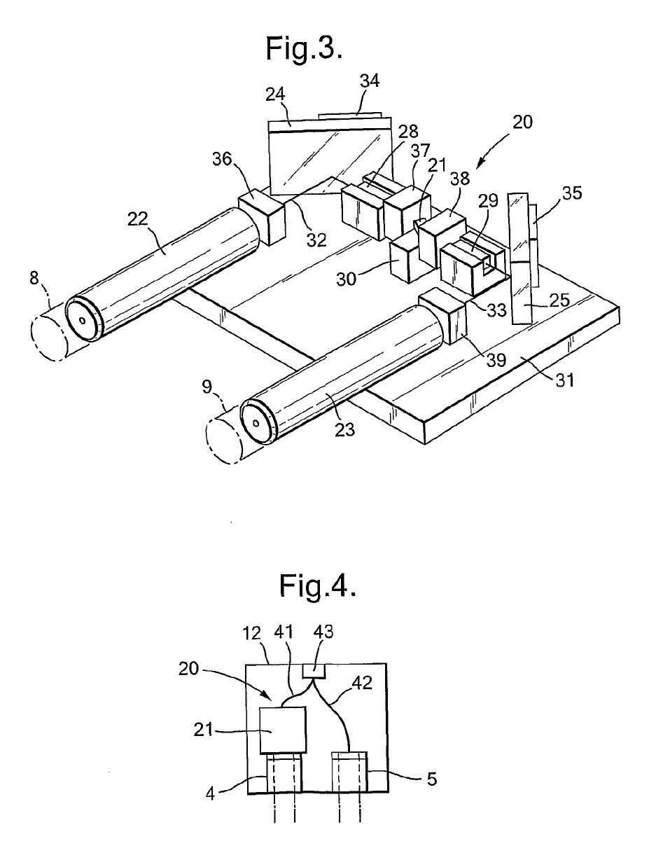

FIG. 3 is a perspective view of the optical subassembly of the fibre-optic module of FIG. 1;

FIG. 4 is a diagram of a first alternative optical subassembly,

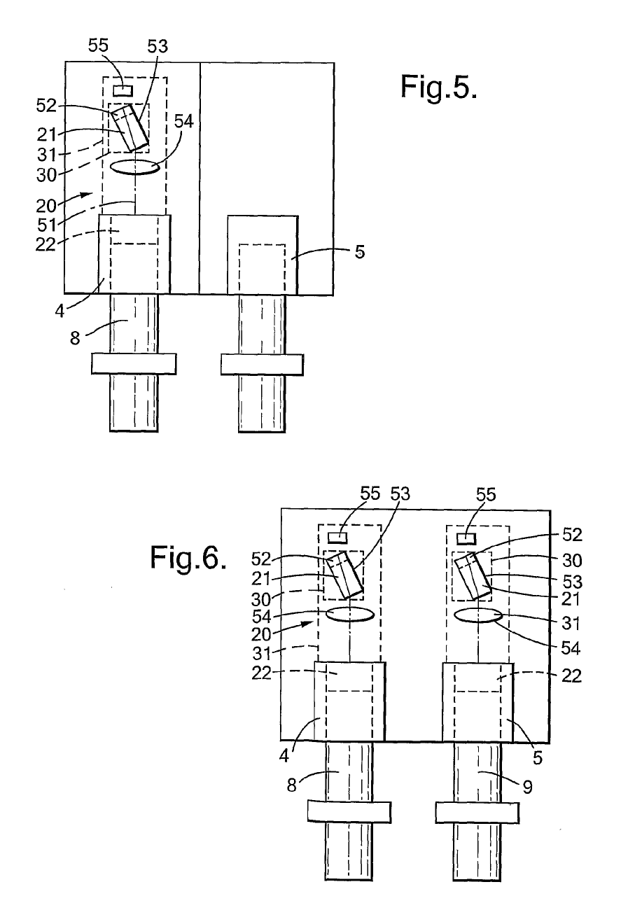

FIG. 5 is a diagram of a third alternative optical subassembly,

FIG. 6 is a diagram of a fourth alternative optical subassembly;

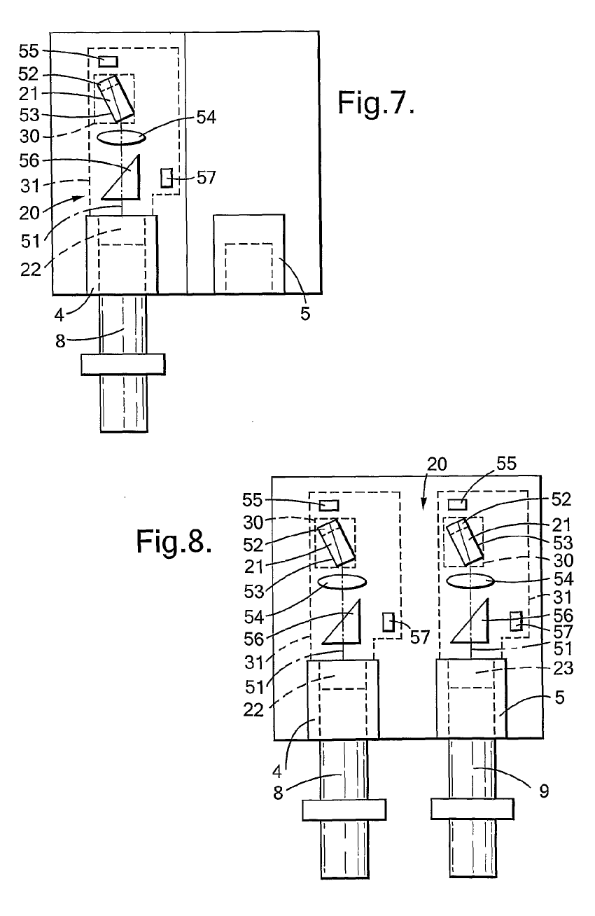

FIG. 7 is a diagram of a fifth alternative optical subassembly, and

FIG. 8 is a diagram of a sixth alternative optical subassembly.

Various embodiments are described which are modifications of other embodiments. To avoid repetition, common components are given the same reference numerals and a description thereof is not repeated.

FIG. 1 shows a fibre-optic module 1 which is an embodiment of the present invention. The fibre-optic module 1 has an external configuration in accordance with the SFP specification, which is a specification for transceiver modules. The SFP specification is intended for a transceiver module which includes a receiver capable of converting an input optical signal into an input electrical signal and a receiver capable of converting an output electrical signal into an output optical signal.

As the external configuration of the fibre-optic module 1 meets the SFP specification, the internal electrical and optical components are housed in a housing 2 having a general elongate configuration allowing it to be plugged into an electrical backplane by sliding it rearwardly along the direction A, as will be described in more detail below.

At the front end of the housing 2, the fibre-optic module 1 has a head 3 which is a unitary element in which there are formed first and second optical connectors 4 and 5 in accordance with the SFP specification. Accordingly, the first and second optical connectors 4 and 5 take the form of sockets having a standard shape which allows receipt of matching plugs 6 and 7 provided on the end optical fibres 8 and 9. When the plugs 6 and 7 are plugged into the optical connectors 4 and 5 as shown by the arrows B, the first optical connector 4 is connected to the first optical fibre 8 for receipt of an input optical signal from the first optical fibre 8, and similarly the second optical connector 5 is connected to the second optical fibre 9 for transmission of an output optical signal along the second optical fibre 9.

The housing 2 of the fibre-optic module 1 is formed as a base 10 and a cover 11, as shown in FIG. 2 which is an exploded view of the fibre-optic module 1 with the cover 11 removed. Inside the housing 2, the fibre-optic module 1 comprises a container 12 for an optical subassembly 20 (described below with reference to FIG. 3) and a circuit board 13 which mounts a control circuit 14. The components of the optical subassembly 20 are hermetically sealed inside the container 12.

The circuit board 13 is formed, at the rear end of the fibre-optic module 1, with an electrical parallel connector 15 in the form of an array of contacts 16 on a tongue 17 of the circuit board 13. The cover 11 is open at the rear end of the fibre-optic module so that the electrical parallel connector 15 is exposed. The electrical parallel connector 15 has a physical configuration in accordance with the SFP specification. This allows the electrical parallel connector 15 to be slid into a cage and plugged into an external electrical connector 18 of an electrical backplane 19 also arranged in accordance with the SFP specification so that the external electrical connector 18 can also receive and use fibre-optic transceiver modules in accordance with the SFP specification. This allows the fibre-optic module 1 to be plugged into existing electrical backplanes meaning that no other equipment is required.

The optical subassembly 20 contained in the container 12 is shown in FIG. 3 and will now be described.

In accordance with the SFP specification, transceiver modules include a receiver optical subassembly (ROSA) which is connected to receive a first optical signal from the first optical connector 4 and converts it into an input electrical signal and a separate transmitter optical subassembly (TOSA) which is connected to the second optical fibre 9 and converts an output electrical signal into an output optical signal which is transmitted along the second optical fibre 9.

In contrast, the optical subassembly 20 of the fibre-optic module 1 is double-ended and in accordance with the first aspect of the invention. In particular, the optical subassembly 20 passes light input at the first connector 4 from the first optical fibre 8 around an optical circuit to be output at the second connector 5 along the second optical fibre 9. As such, the container 12 and the optical subassembly 20 of the fibre-optic module 1 are positioned in a space within the fibre-optic module 1 which corresponds to the position of the TOSA and the ROSA in transceiver modules in accordance with the SFP specification. The optical subassembly 20 may be designed using similar packaging techniques as applied to existing TOSAs and ROSAs in order to keep the cost low and to utilise the existing piece parts.

The optical subassembly 20 comprises a train of optical components mounted on a substrate 31 arranged with free space therebetween to form an optical circuit which passes the input optical signal received at the first connector 4 along an optical path 32 from the first optical fibre 8 through the SOA 21 for amplification to form an amplified optical signal, and then passes the amplified optical signal along an optical path 33 to the second optical connector 5 and transmits it as the output optical signal along the second optical fibre 9. In one embodiment, the SOA 21 is operated in its linear region so that it amplifies the input optical signal to provide the output signal without change to the content of the signal. Thus the fibre-optic module 1 may used for example for pre-amplification or for high power signal boosting over a wide range of wavelengths.

The optical train arrangement with space between the components provides advantages over the use of a continuous waveguide arrangement. The overall size of the optical subassembly 20 is reduced when account is taken of the cooling requirement as described below. This configuration also provides increased free space within the optical subassembly 20 which allows the accommodation of additional components.

However, the optical subassembly 20 could alternatively use a continuous waveguide arrangement in which the light is directed along waveguides, for example formed in a passive waveguide structure.

The optical connectors 4 and 5 are each terminated by a respective optical fibre stub 22 and 23 which optically couples with the respective optical fibre 8 and 9 when connected (as shown in dotted outline in FIG. 3). The optical fibre stubs 22 and 23 couple light into and out of the optical circuit formed by the optical subassembly 20.

As a result of the optical connectors 4 and 5 being alongside each other in accordance with the SFP specification, the light of the input optical signal output from the optical fibre stub 22 of the first connector 4 passes in an anti-parallel direction to the light of the output optical signal received by the optical fibre stub 23 of the second connector 5. In order to cause the necessary change in the direction of the light, the optical subassembly 20 includes a pair of reflectors 24 and 25. The first reflector 24 is arranged to reflect the input light from the first connector 4 and the second reflector 5 is arranged to reflect the light from the first reflector 24 to the second connector 5. Each of the connectors 24 and 25 is arranged at an angle of 45° to the optical axis in order to reflect the incident light through 90°, although in principle other angles could be used to change the direction of the light.

As described below there are other alternatives for changing the direction of the light, but the use of the pair of reflectors 24 and 25 is preferred because it provides a very compact arrangement in that it changes the direction of the light within a small volume. This facilitates the housing of the optical subassembly 20 in the same space as the TOSA and ROSA of a transceiver module in accordance with the SFP specification.

The SOA 21 is arranged between the pair of reflectors 24 and 25. This location for the SOA 21 is particularly convenient, as compared to the alternative of arranging the SOA 21 on the input side of the first reflector 24 or the output side of the second reflector 25, because it again provides for a compact arrangement of the optical subassembly 20. In fact, such a packaging arrangement for an SOA in which the input and output are on the same side of the package is very unusual, but in the present context this enables the SFP format.

The SOA 21 is a buried heterostructure SOA which is advantageous in reducing the power consumption. This has a particular advantage in the context of the fibre-optic module 1 being plugged into the electrical backplane 19 adjacent transceiver modules in accordance with the SFP specification which imposes certain constraints on the power consumption of individual modules. In principle, though, the SOA 21 could have an alternative design.

The SOA 21 is arranged with end facets and which are at a small angle to the path of the incident and emitted light in order to reduce reflection and coupling losses.

In order to couple the light between the fibre stubs 22 and 23 and the SOA 21, the optical circuit uses a lensed configuration. In particular, two lenses 36 and 37 on the input side of the SOA 21 directs the input light into the waveguide of the SOA 21, and two lenses 38 and 39 on the output side of the SOA 21 collects light output from the waveguide of the SOA 21. The lens 36 is arranged adjacent the optical fibre stub 22 and collimates the light output from the optical fibre stub 22 into a beam, whereas the lens 37 is arranged adjacent the SOA 21 and directs the beam from the lens 37 onto the SOA 21. In the same manner, the lens 38 is arranged adjacent the SOA 21 and collimates the light output from the SOA 21 into a beam, whereas the lens 39 is arranged adjacent the optical fibre stub 23 and directs the beam from the lens 38 onto the optical fibre stub 23. Although this configuration of lenses 36 to 38 is collimated, this is not essential and the light passing between the lenses may be uncollimated. Similarly, it is possible to use an uncollimated approach including a single lens on the input side of the SOA 21 and a single lens on the output side of the SOA 21.

The advantage of this lensed configuration is that it facilitates the optical train arrangement of the optical subassembly 20.

The optical circuit provided by the optical subassembly 20 further includes first and second isolators 28 and 29 arranged on respectively the input side and the output side of the SOA 21. Thus, the input optical signal received from the first optical fibre 8 passes through the first isolator 28 before the SOA 21 and the amplified optical signal output from the SOA 21 passes through the second isolator 29 before transmission along the second optical fibre 9 as the output optical signal. The isolators 28 and 29 take the form of fibre isolators. The particular locations for the first and second isolators 28 and 29 are between the reflectors 24 and 25 and the SOA 21. As an alternative, the first and second isolators 28 and 29 could be located between the optical fibre stubs 22 and 23 and the reflectors 24 and 25.

The optical subassembly 20 is further provided with power taps for monitoring of the power of the input optical signal and the output optical signal. The power taps are implemented by respective photodiodes 34 and 35 mounted on the rear of the reflectors 24 and 25, the reflectors 24 and 25 transmitting a small proportion of the light incident thereon to the photodiodes 34 and 35. Alternatively, the power taps may be integrated in the isolators 28 and 29, or implemented in some other way.

The SOA 21 is provided with a thermoelectric cooler 30 on which the SOA 21 is mounted, although the optical subassembly 20 could alternatively use an SOA 21 which is uncooled. The thermoelectric cooler 30 may incorporate a thermistor (not shown) for monitoring the temperature of the SOA 21.

As shown, the thermoelectric cooler 30 cools only the SOA 21 in order to minimise the heat absorbed by the SOA 21 and submount from the environment and minimise the size of the thermoelectric cooler 30 and maximise the radiation of the heat produced. This is possible because the optical train design of the other components of the optical subassembly 20 provides sufficient tolerance to movement of those components associated with the differential in temperature with the SOA 21. Alternatively, the thermoelectric cooler 30 could also cool the lenses 37 and 38 adjacent the SOA 21, but even in this case the thermoelectric cooler 30 can be relatively small. The head 3 which incorporates the optical connectors 4 and 5 radiates heat generated by the optical subassembly 21 as a result of being placed at the front end of the fibre-optic module 21 which is exposed, the other sides of the fibre-optic module 1 being in use adjacent other modules such as transceiver modules.

The power requirement of the optical subassembly 21 comes from the drive current of the SOA 20 and the power requirement of the thermoelectric cooler 30. The drive current of the SOA 20 is relatively low, compared to other optical amplifiers such as doped fibre amplifiers and doped waveguide amplifiers, in particular EDFAs and EDWAs. This together with the low cooling requirement discussed above means that the optical subassembly can meet the power limitations of the SFP specification. In particular, the maximum power dissipation specified by the SFP specification is 1 W. A 70° C. maximum operating temperature is also specified, but with effective internal temperature of approx 80 C. These requirements can be met. In one actual embodiment, the power of the thermoelectric cooler 30 is around 0.5 W and the power used in driving the SOA 20 is 0.3 W for a semi-cooled operation where the SOA 20 is cooled to around 40° C., rather than the usual 20° C.

In addition, the optical subassembly 20 has a compact configuration allowing it to be fitted within the compartment 20 corresponding to the space provided for the TOSA and the ROSA of a transceiver module in accordance with the SFP specification. This small form factor is achieved particularly through the choice of an SOA 21 as the optical amplifier.

As previously mentioned, a control circuit 14 is provided on the circuit board 13. The control circuit 14 is arranged to drive and control the SOA 21. The control occurs in a similar manner to that of a DWDM laser which is one type of transmitter employed in TOSAs of transceiver modules. The control circuit 14 is implemented by a PIC (peripheral interface controller) microcontroller, and is connected to the electrical parallel connector 15. Accordingly, the control circuit 14 receives control signals from the electrical parallel connector 15, in response to which the SOA 21 is controlled.

The control circuit 14 is arranged to provide an electrical interface which is very similar to that of the transceiver modules in accordance with the SFP specification. Advantageously, the electrical interface with the fibre-optic module 1 will be in accordance with the SFP specification, except where changes are required in view of the need to control the SOA 21, rather than a TOSA and ROSA of a transceiver module. This allows intelligent control of the SOA 21 which means that the SOA 21 and other components of the optical subassembly 20 can be used without detailed knowledge of how to use them. For example, the control circuit 14 may implement a slow start for the SOA 21 for protection. Similarly, there may be control of the drive current to protect the SOA 21 against high input power. In the case of detection of the absence of an input signal, the SOA 21 may be shut down in anticipation of a signal surge on connection. A maximum output power condition may be set. The performance of the SOA 21 can be optimised to avoid power saturation and signal distortion.

Similarly, the control circuit 14 can provide monitor signals which may identify the fibre-optic module 1 as one which includes an optical amplifier or may be representative of operational parameters of the optical subassembly 20 and in particular the SOA 21. For example, the monitor signals may report the optical input and output power, errors and/or other operational parameters. Again, the monitor signals will advantageously be in accordance with the SFP specification except where differences are required as the result of use of the SOA 21.

In use, typically there will be a plurality of electrical backplanes 19 arranged in a rack. The electrical backplanes 19 will provide a large number of external electrical connectors 18. In existing systems, the electrical connectors 18 will all receive transceiver modules. However, the fibre-optic module 1 may be plugged into some of the external electrical connectors 18. Then the optical fibres 8 and 9 may be plugged into the fibre-optic module 1 and into the transceiver modules to route optical signals passing to or from the transceiver modules through the fibre-optic module 1 which is then operated to augment the optical performance of the transceiver modules by amplifying the optical signals to a desirable level.

Although the fibre-optic module 1 is based on the SFP specification, an equivalent module could be based on any other standard specification for a transceiver module.

Some alternative designs for the optical subassembly 20 will now be described.

A first alternative design for the optical subassembly 20 is shown in FIG. 4. In this case, the optical subassembly 20 is double-ended and in accordance with the first aspect of the invention. The SOA 21 is arranged in line with the first optical connector 4 (although it could alternatively be arranged in line with the second connector 5). The optical circuit further includes two optical fibres 41 and 42, the first optical fibre 41 being connected from the SOA 21 to a reflector 43, the second optical fibre 42 being arranged in series with the first optical fibre 41 by being connected from the reflector 43 to the second optical connector 5. The optical reflector 43 may be a fibre reflector. Use of the reflector 43 allows the direction of the light to be reversed, thereby allowing the light to be directed from the first connector 4 to the second connector 5. The fibre reflector 43 can also provide power monitoring. As an alternative to the two optical fibres 41 and 42 and the reflector 43, it would be possible to use a single optical fibre connected from the SOA 21 to the second connector 5 which would require the use of a fibre having a tight bend radius. The advantage of this alternative arrangement is a reduction in cost.

A second alternative design for the optical subassembly 20 is to use an SOA formed as a reflective amplifier chip. In this case, one possible configuration is to use a circulator to divide the input optical signal and the output optical signal associated with one optical interface of the chip.

There will now be described some further alternative designs for the optical subassembly 20 in which the optical subassembly 20 is single-ended and in accordance with the second aspect of the invention. In particular, in these alternative designs, the optical subassembly 20 is single-ended in that light of an input optical signal is received from the same optical fibre as is used to transmit light of an output optical signal. In such a configuration, a circulator which has a single port associated with the amplifier may be used as an external component to separate the input optical signal and the output optical signal.

A third alternative design for the optical subassembly 20 is shown in FIG. 5. In this arrangement, the SOA 21 is normally operated in its linear region although non-linear operation is also possible. In one application, the SOA21 may amplify the input optical signal to provide the output signal without change to the content of the signal. In another application, the SOA21 may also be used to modulate the light to transmit data upstream, perhaps on a temporal multiplexing basis in a time slot in which the input optical signal contains no data. Thus the fibre-optic module 1 may use for example for pre-amplification or for high power signal boosting over a wide range of wavelengths.

In the third alternative design, the optical subassembly 20 uses the first connector 4 to receive an input optical signal from the optical fibre 8 and to transmit the output optical signal to the same optical fibre 8. As such, the container 12 and the optical subassembly 20 of the fibre-optic module 1 are positioned in a space within the fibre-optic module 1 which corresponds to the position of the TOSA and the ROSA in transceiver modules in accordance with the SFP specification. The optical subassembly 20 may be designed using similar packaging techniques as applied to existing TOSAs and ROSAs in order to keep the cost low and to utilise the existing piece parts.

The optical subassembly 20 comprises a train of optical components mounted on a substrate 31 arranged with free space therebetween to form an optical circuit which passes the light of the input optical signal received at the first connector 4 along an optical path 51 to the SOA 21 for amplification, and passes light of the output optical signal output from the SOA 21 in the opposite direction from the input optical signal back along the same optical path 51 to the first connector 4. The SOA 21 is arranged with end facets and which are at a small angle to the optical path 51 in order to reduce reflection and coupling losses. The optical train arrangement with space between the components provides advantages over the use of a continuous waveguide arrangement. The overall size of the optical subassembly 20 is reduced when account is taken of the cooling requirement as described below. This configuration also provides increased free space within the optical subassembly 20 which allows the accommodation of additional components.

However, the optical subassembly 20 could alternatively use a continuous waveguide arrangement in which the light is directed along waveguides, for example formed in a passive waveguide structure.

To achieve the single-ended design, the optical subassembly 20 has a reflector 52 which reflects the light after a first pass through the SOA 21 back through the SOA 21. The reflector 52 is in this embodiment integrated into the same semiconductor chip 53 as the SOA 21. One possibility is that the reflector 52 is formed on the rear facet of the semiconductor chip 53, for example as a mirror coating. Another possibility is that the reflector 52 is formed by a grating in the semiconductor chip 53. This allows the reflector 52 also to act as a filter giving specific reflection characteristics, such as band pass. Such wavelength selectivity enables for example the rejection of wavelengths which are not required at the output of the SOA 21. This can reduce the total spontaneous emission power, improving the signal-to-noise ratio. Also, the rejected signal can be collected outside the rear facet for power monitoring or, for example, for detection of a downstream signal at a different wavelength to upstream transmission. Here the downstream data benefits either from pre-amplification prior to detection or sees a transparent waveguide depending upon wavelength.

As an alternative, the SOA21 itself could be used in reverse bias to detect the downstream data represented by the input optical signal, perhaps on a temporal multiplexing basis in a particular time slot.

As a further alternative, the reflector 52 could be implemented by a separate component arranged behind the rear facet of the SOA 21.

The first optical connector 4 is terminated by an optical fibre stub 22 which optically couples with the optical fibre 8 when connected. The optical fibre stub 22 couples light into and out of the optical circuit formed by the optical subassembly 20.

In order to couple the light between the fibre stub 22 and the SOA 21, the optical circuit uses a lensed configuration. In particular, a lens 54 is provided in the optical path 52 between the first connector 4 and the SOA 21. The lens directs the input light from the first connector 4 into the waveguide of the SOA 21, and similarly collects light output from the waveguide of the SOA 21 and directs it into the fibre stub 22. The advantage of this lensed configuration is that it facilitates the optical train arrangement of the optical subassembly 20.

The optical subassembly 20 is further provided with a photodiode 55 acting as a power tap for monitoring of the power of the optical signal after one pass through the SOA. The photodiode 55 is mounted behind the rear facet of the SOA 21 and receives a small proportion of the light which is not reflected by the reflector 55. Alternatively, the power tap may be implemented in some other way.

Optionally, and in dependence on the environment and performance requirements, the SOA 21 is provided with a thermoelectric cooler 30 on which the SOA 21 is mounted, although the optical subassembly 20 could alternatively use an SOA 21 which is uncooled. The thermoelectric cooler 30 may incorporate a thermistor (not shown) for monitoring the temperature of the SOA 21.

As shown, the thermoelectric cooler 30 cools only the SOA 21 in order to minimise the heat absorbed by the SOA 21 and submount from the environment and minimise the size of the thermoelectric cooler 30 and maximise the radiation of the heat produced. This is possible because the optical train design of the other components of the optical subassembly 20 provides sufficient tolerance to movement of those components associated with the differential in temperature with the SOA 21. Alternatively, the thermoelectric cooler 30 could also cool the lenses 37 and 38 adjacent the SOA 21, but even in this case the thermoelectric cooler 30 can be relatively small. The head 3 which incorporates the optical connectors 4 and 5 radiates heat generated by the optical subassembly 21 as a result of being placed at the front end of the fibre-optic module 21 which is exposed, the other sides of the fibre-optic module 1 being in use adjacent other modules such as transceiver modules.

The power requirement of the optical subassembly 21 comes from the drive current of the SOA 20 and the power requirement of the thermoelectric cooler 30. The drive current of the SOA 20 is relatively low, compared to other optical amplifiers such as doped fibre amplifiers and doped waveguide amplifiers, in particular EDFAs and EDWAs. This together with the low cooling requirement discussed above means that the optical subassembly can meet the power limitations of the SFP specification.

In addition, the optical subassembly 20 has a compact configuration allowing it to be fitted within the compartment 20 corresponding to the space provided for the TOSA and the ROSA of a transceiver module in accordance with the SFP specification. This small form factor is achieved particularly through the choice of an SOA 21 as the optical amplifier.

In the third alternative design shown in FIG. 5, the optical subassembly in facts fits in half the space provided for the TOSA and the ROSA of a transceiver module in accordance with the SFP specification. The other half of the space is therefore free for other components. The space may accommodate a further cooler. Alternatively, the space may accommodate a second optical circuit, including a second SOA 21, identical to that of FIG. 5 but optically connected to the second connector 5 for connection to the second optical fibre 9. An example of this is shown in FIG. 6 which constitutes the fourth alternative design for the optical subassembly 20.

A fifth alternative design for the optical subassembly 20 is shown in FIG. 5. The fifth alternative design is identical to the third alternative design, except for the modifications described below. These modifications are made to assist use of the SOA 21 in its non-linear region.

In such uses, the SOA 21 can simultaneously use gain saturation capability to strip downstream data represented by the input optical signal and modulation capability to transmit data upstream represented by the input optical signal. In order to split off and detect the downstream data represented by the input optical signal split off, the optical subassembly includes a 90° reflector 56 arranged in the optical path 51 between the first connector 56 and the SOA 21. The 90° reflector 56 reflects part of the power of the input optical signal to a second photodiode 57, the remaining power of the input optical signal continuing along the optical path 51 to the SOA 21. The second photodiode 57, as well as acting as an input power monitor, acts as detector for the downstream data represented by the input optical signal. Under the control of the control circuit 14, the downstream data is received by the second photodiode and output in serial timeslots. The downstream data is output from the fibre-optic module over the electrical parallel connector 15.

The light of the input optical signal which passes to the SOA 21 saturates the SOA 21. Thus the modulation of the input optical signal is lost. However, the SOA 21 is operated to modulate the light in accordance with the upstream data received at the fibre optic module over the electrical parallel connector 15, so that the output optical signal represents the upstream data. The output power can be monitored by the first photodiode 55.

Optionally, the optical subassembly can incorporate a filter to separate downstream and upstream wavelengths, thereby allowing wavelength multiplexing rather than temporal multiplexing as discussed above.

The fifth alternative design shown in FIG. 5, the optical subassembly in facts fits in half the space provided for the TOSA and the ROSA of a transceiver module in accordance with the SFP specification. The other half of the space is therefore free for other components. The space may accommodate a further cooler. Alternatively, the space may accommodate a second optical circuit, including a second SOA 21, identical to that of FIG. 7 but optically connected to the second connector 5 for connection to the second optical fibre 9. An example of this is shown in FIG. 8 which constitutes the sixth alternative design for the optical subassembly 20.

1. A fibre-optic module having an external configuration in accordance with a standard specification for a fibre-optic transceiver module in which the transceiver module has an electrical parallel connector and optical connectors capable of connection to first and second optical fibres to receive an input optical signal from the first optical fibre and to transmit an output optical signal along the second optical fibre, and in which the transceiver module is capable of converting the input optical signal into an input electrical signal and of converting an output electrical signal into the output optical signal,
wherein the fibre-optic module comprises:
first and second optical connectors capable of connection to first and second optical fibres to receive an input optical signal from the first optical fibre and to transmit an output optical signal along the second optical fibre, the optical connectors being in accordance with said standard specification;
an optical amplifier;
an optical circuit arranged to pass the input optical signal received from the first optical fibre to the optical amplifier for amplification, and to pass the amplified optical signal output from the optical amplifier to the second optical connector for transmission as the output optical signal along the second optical fibre;
an electrical parallel connector having a physical configuration in accordance with said standard specification; and
a control circuit arranged to receive control signals from the electrical parallel connector and to control the operation of the optical amplifier in response to said control signals.

2. A fibre-optic module according to claim 1, wherein the optical amplifier is a semiconductor optical amplifier.

3. A fibre-optic module according to claim 2, wherein the optical circuit comprises a train of optical elements with free space therebetween.

4. A fibre-optic module according to claim 3, wherein the first and second optical connectors are alongside each other, and the optical circuit includes a pair of reflectors arranged to direct the light passed through the optical circuit from the first optical connector to the second optical connector.

5. A fibre-optic module according to claim 4, wherein the semiconductor optical amplifier is arranged in the optical circuit between the pair of reflectors.

6. A fibre-optic module according to claim 3, wherein the optical circuit comprises at least one lens on the input side of the optical amplifier arranged to direct the light of the input optical signal onto the semiconductor optical amplifier, and at least one lens on the output side of the semiconductor optical amplifier arranged to collect the light of the output optical signal from the semiconductor optical amplifier.

7. A fibre-optic module according to claim 3, wherein the optical circuit comprises first and second isolators, the optical circuit being arranged to pass the input optical signal received from the first optical fibre through the first isolator before the semiconductor optical amplifier, and to pass the amplified optical signal output from the semiconductor optical amplifier through the second isolator before the second optical connector.

8. A fibre-optic module according to claim 3, wherein the optical connectors each comprise an optical fibre stub which optically couples to the respective optical fibre when the optical fibre is connected.

9. A fibre-optic module according to any claim 2, further comprising a thermoelectric cooler disposed adjacent the semiconductor optical amplifier.

10. A fibre-optic module according to claim 1, wherein the control circuit is a PIC microcontroller.

11. A fibre-optic module according to claim 1, wherein the control circuit is further arranged to supply to the electrical parallel connector monitor signals representative of operational parameters of the module.

12. A fibre-optic module according to claim 1, wherein the electrical parallel connector has a configuration allowing the electrical parallel connector to be plugged into an external electrical connector of an electrical backplane for receiving fibre-optic transceiver modules in accordance with said standard specification.

13. A fibre-optic module according to claim 12, wherein said standard specification is one of the XFP specification, the SFP specification, the XPAK specification, the SFF specification, the XENPAK specification, or the X2 specification.

14. A fibre-optic module according to claim 1, wherein said standard specification is one of the XFP specification, the SFP specification, the XPAK specification, the XENPAK specification, or the X2 specification.

15. A fibre-optic module according to claim 1, wherein the first and second optical connectors are formed as a unitary element.

16. A pluggable fibre-optic module, comprising:
an electrical parallel connector having a configuration allowing the electrical parallel connector to be plugged into an external electrical connector of an electrical backplane for receiving fibre-optic transceiver modules;
first and second optical connectors capable of connection to first and second optical fibres to receive an input optical signal from the first optical fibre and to transmit an output optical signal along the second optical fibre;
an optical amplifier;
an optical circuit arranged to pass the input optical signal received at the first optical connector from the first optical fibre through the optical amplifier to form an amplified optical signal, and arranged to pass the amplified optical signal to the second optical connector for transmission as the output optical signal along the second optical fibre; and
a control circuit connected to the electrical parallel connector and arranged to control the operation of the optical amplifier.

17. A fibre-optic module having an external configuration in accordance with a standard specification for a fibre-optic transceiver module in which the transceiver module has an electrical parallel connector and optical connectors capable of connection to first and second optical fibres to receive an input optical signal from the first optical fibre and to transmit an output optical signal along the second optical fibre, and in which standard specification the transceiver module is capable of converting the input optical signal into an input electrical signal and of converting an output electrical signal into the output optical signal,
wherein the fibre-optic module comprises:
an optical connector capable of connection to an optical fibre to receive an input optical signal from the optical fibre and to transmit an output optical signal along the optical fibre, the optical connector being in accordance with said standard specification;
an optical amplifier;
a reflector;
an optical circuit arranged to pass the input optical signal received from the optical fibre to the optical amplifier, the reflector being arranged to reflect the light after a first pass through the optical amplifier back through the optical amplifier, and the optical circuit being arranged to direct the light output from the optical amplifier after a second pass through the optical amplifier back to the optical connector for transmission as the output optical signal along the optical fibre;
an electrical parallel connector having a physical configuration in accordance with said standard specification; and
a control circuit arranged to receive control signals from the electrical parallel connector and to control the operation of the optical amplifier in response to said control signals.

18. A fibre-optic module according to claim 17, wherein the optical amplifier is a semiconductor optical amplifier.

19. A fibre-optic module according to claim 18, wherein the semiconductor optical amplifier and the reflector are integrated into a common semiconductor chip.

20. A fibre-optic module according to claim 18, wherein the optical circuit comprises a train of optical elements with free space therebetween.

21. A fibre-optic module according to claim 20, wherein the optical circuit comprises at least one lens between the optical connector and the semiconductor optical amplifier arranged to direct the light of the input optical signal onto the semiconductor optical amplifier and to collect the light of the output optical signal from the semiconductor optical amplifier and direct it to the optical connector.

22. A fibre-optic module according to claim 20, wherein the optical connector comprises an optical fibre stub which optically couples to the respective optical fibre when the optical fibre is connected.

23. A fibre-optic module according to claim 18, further comprising a thermoelectric cooler disposed adjacent the semiconductor optical amplifier.

24. A fibre-optic module according to claim 17, wherein the control circuit is a PIC microcontroller.

25. A fibre-optic module according to claim 17, wherein the control circuit is further arranged to supply to the electrical parallel connector monitor signals representative of operational parameters of the module.

26. A fibre-optic module according to claim 17, wherein the electrical parallel connector has a configuration allowing the electrical parallel connector to be plugged into an external electrical connector of an electrical backplane for receiving fibre-optic transceiver modules in accordance with said standard specification.

27. A fibre-optic module according to claim 26, wherein said standard specification is one of the XFP specification, the SFP specification, the XPAK specification, the SFF specification, the XENPAK specification, or the X2 specification.

28. A fibre-optic module according to claim 17, wherein said standard specification is one of the XFP specification, the SFP specification, the XPAK specification, the XENPAK specification, or the X2 specification.

29. A fibre-optic module according to claim 17, further comprising:
a second optical connector capable of connection to a second optical fibre to receive a second input optical signal from the second optical fibre and to transmit a second output optical signal along the optical fibre, the first mentioned optical connector and the second optical connector being in accordance with said standard specification;
a second optical amplifier;
a second reflector;
a second optical circuit arranged to pass the input optical signal received from the second optical fibre to the second optical amplifier, the second reflector being arranged to reflect the light after a first pass through the second optical amplifier back through the second optical amplifier, and the second optical circuit being arranged to direct the light output from the second optical amplifier after a second pass through the second optical amplifier back to the second optical connector for transmission as the output optical signal along the second optical fibre.

30. A fibre-optic module according to claim 29, wherein the first and second optical connectors are formed as a unitary element.

31. A pluggable fibre-optic module, comprising
an electrical parallel connector having a configuration allowing the electrical parallel connector to be plugged into an external electrical connector of an electrical backplane for receiving fibre-optic transceiver modules;
an optical connector capable of connection to an optical fibre to receive an input optical signal from the optical fibre and to transmit an output optical signal along the optical fibre;
an optical amplifier;
a reflector;
an optical circuit arranged to pass the input optical signal received from the optical fibre to the optical amplifier, the reflector being arranged to reflect the light after a first pass through the optical amplifier back through the optical amplifier, and the optical circuit being arranged to direct the light output from the optical amplifier after a second pass through the optical amplifier back to the optical connector for transmission as the output optical signal along the optical fibre;
a control circuit connected to the electrical parallel connector and arranged to the operation of the optical amplifier.
